(19) United States
(12) Patent Application Publication
(10) Pub. No.: US 2014/0175980 A1
(43) Pub. Date: Jun. 26, 2014

(54) SYSTEM AND METHOD FOR IMPROVED RAPID CYCLING PERFORMANCE OF INSTANT START FLUORESCENT LAMPS

(71) Applicant: GENERAL ELECTRIC COMPANY, Schenectady, NY (US)

(72) Inventors: Jacint Gergely, Budapest (HU); Laszlo Petras, Budapest (HU); Peter Lucz, Budapest (HU); Gabor Schmidt, Budapest (HU); Peter Almosdi, Budapest (HU)

(73) Assignee: GENERAL ELECTRIC COMPANY, Schenectady, NY (US)

(21) Appl. No.: 13/723,022

(22) Filed: Dec. 20, 2012

(51) Int. Cl. H05B 41/38

(52) U.S. Cl. CPC H05B 41/388
USPC 315/98; 315/94

(57) ABSTRACT

Provided is a system for improving rapid cycling performance of instant start compact self-ballasted fluorescent lamps. The system provides a ballast driver circuit including a lamp driver, a lamp voltage detector, an additional cathode heating driver, and a wire lamp. The additional cathode heating driver applies an additional amount of current to the cathodes of the wire lamp during the glow phase after the ignition of the lamp.

### I. FIELD OF THE INVENTION

The present invention relates generally to power delivery systems and methods for fluorescent lamps. More particularly, the present invention relates to improving rapid cycling performance of instant start self-ballasted compact fluorescent lamps.

### II. BACKGROUND OF THE INVENTION

There are generally two types of ballasts utilized in fluorescent lamps including program-start ballasts and instant-start electronic ballasts. Program start electronic ballasts typically provide a cathode heating current before lamp startup. Pre-heating the cathode before lamp ignition lowers the amount of damage done to the cathode during the glow discharge phase. Minimizing the glow discharge lamp current peaks extends the cathode life since the amount of the tungsten that is sputtered off the electrode during lamp startup is minimized. In instant-start ballasted fluorescent lamps, the lamp current peaks are high. The high current peaks cause significant damage to the cathode, thereby reducing lamp life during rapid cycling.

Program start lighting systems are useful in settings where the lights are frequently turned on and off (i.e., a high number of on/off cycles), such as in a conference room, a lavatory, or other setting that sees frequent non-continuous usage.

Despite its advantages, the program start electronic ballast has a drawback. Because it has to preheat the cathode before it strikes the lamp there is a noticeable delay from activation to emission of visible light. Typically this delay is on the order of 1.5 seconds and is referred to as preheat or waiting time.

The instant start ballast mitigates the disadvantage of the program start ballast. However, it has its own disadvantages. Typically, instant start ballasts do not preheat the cathodes, rather they apply the operating voltage directly to the lamp. In this design, at the moment the switch is turned on, a high voltage is provided across the lamp and the lamp will ignite quickly. The lamp, therefore, has a much shorter ignition time (typically less than 0.1 seconds) as compared to the program start systems, and light is seen immediately upon activation. Also, there is no additional extra current drain to the cathode during operation since the operating voltage is applied directly to the lamp cathodes.

However, instant start ballasts produce undesirable glow discharge current peaks which degrade the integrity of the cathodes. Over time, the cathodes of the instant start ballasts degrade at a rate that results in premature failure of the lamp.

The preferred solution to reduce the undesirable glow current peaks has been to preheat the cathodes with a heating current before the ignition process. This preheating typically requires a longer lamp startup period. Consequently, it is desirable to have a lamp ballast system with longer lamp life as well as quick start time.

### III. SUMMARY OF THE EMBODIMENTS OF INVENTION

Given the aforementioned deficiencies, what is needed, therefore, is a system for providing additional heating to increase cathode current during glow phase without increasing lamp current. What are also needed are systems and methods for decreasing the additional heating to the cathode following the glow-to-arc phase.

Embodiments of the present invention provide a lighting system including a lamp driver, a lamp voltage detector, an additional cathode heating driver, and a wire lamp.

In the embodiments, the lighting circuit is configured to provide additional heating to the cathode of a fluorescent lamp during the glow phase of the lamp, i.e., following ignition of the lamp. The additional heating reduces the duration of the glow phase. Following the glow phase, the additional heating circuit also decreases the additional heating to the cathode to improve the efficiency of the lamp.

In at least one aspect, the embodiments provide a lighting system including a wire lamp, a lamp driver in communication with the wire lamp, a lamp voltage detector in communication the lamp driver and the wire lamp; and an additional cathode heating driver in communication with the lamp voltage detector and the wire lamp. During operation, the additional cathode heating driver causes additional heat to be applied to the wire lamp such that the current peaks of the wire lamp are substantially reduced or eliminated.

In yet another aspect, the embodiments provide a lighting system including, a ballast in electrical communication with a lamp, an additional cathode heating driver in communication with the ballast, and first and second cathode heating loops in communication with the ballast. The system also includes a wire lamp having first and second cathodes, the wire lamp being in communication with the additional cathode heating driver. The first cathode heating loop includes a first coil, and a first cathode of the wire lamp in communication with the first coil. The second heating loop includes a second coil, and a second cathode of the wire lamp in communication with the second coil. During operation, the wire lamp receives additional heat from the additional cathode heating driver to reduce the current peaks of the wire lamp.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram illustration of a self-ignited compact fluorescent lamp ballast in accordance with an embodiment of the present invention.

FIG. 2 is a circuit diagram of a self-ignited compact fluorescent lamp ballast in accordance with embodiments of the present invention.

FIG. 3 is a circuit diagram of a self-ignited compact fluorescent lamp ballast in accordance with the embodiments.

FIG. 4 is flowchart of an exemplary method in accordance with an embodiment of the present invention.

FIG. 5A is an exemplary screenshot of electrical measurements of a self-ignited compact fluorescent lamp without additional cathode heating.

FIG. 5B is an exemplary screenshot of electrical measurements of a self-ignited compact fluorescent lamp with additional cathode heating in accordance with the embodiments.

FIG. 5C is a tabular illustration of exemplary lamp current measurements in accordance with FIGS. 5A and 5B.

FIGS. 5D is a graphical illustration of exemplary lamp current measurements in accordance with FIGS. 5A and 5B.

The drawings are only for purposes of illustrating preferred embodiments and are not to be construed as limiting the disclosure. Given the following enabling description of the drawings, the novel aspects of the present disclosure should become evident to a person of ordinary skill in the art.

### V. DETAILED DESCRIPTION OF EMBODIMENTS OF THE PRESENT INVENTION

The following detailed description is merely exemplary in nature and is not intended to limit the applications and uses disclosed herein. Further, there is no intention to be bound by any theory presented in the preceding background or summary or the following detailed description. While embodiments of the present technology are described herein primarily in connection with instant start compact self-ballasted fluorescent lamps, some of the concepts may also be applicable to other types of fluorescent lamps.

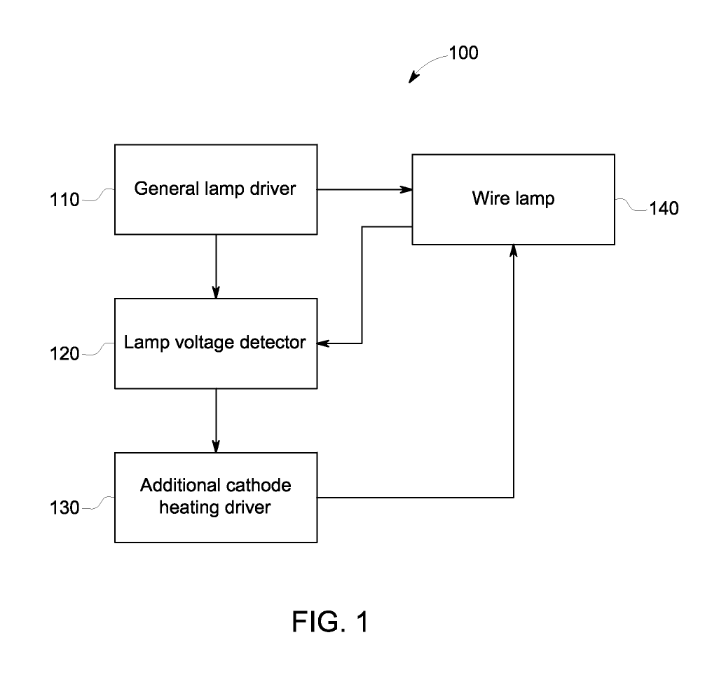

FIG. 1 is a block diagram illustration of a self-ignited compact fluorescent lamp ballast in accordance with an embodiment of the present invention. In FIG. 1, a ballast driver circuit 100 includes a lamp driver 110, a lamp voltage detector 120, an additional cathode heating driver 130, and a lamp (e.g., wire lamp, or other lighting element) 140. In the embodiments, the components of the ballast driver circuit 100 including, for example, the lamp driver 110, lamp voltage detector 120, additional cathode heating driver 130, and lamp 140 are in communication with one or more other components. Communication may include, for example, electrical communication, electrical connection, wired connection, and the like.

During ignition, the lamp driver 110 applies current to the wire lamp 140 to heat and ignite the lamp 140. The ballast driver circuit 100 reduces the damage done to the cathodes of the lamp 140 during the glow phase of the lamp 140 without the use of pre-heating or applying additional heating prior to ignition. The ballast driver circuit 100 thereby increases the lifetime of instant-start lamps when used in frequent-switching user scenarios.

The lamp voltage detector 120 receives and measures the voltage applied to the lamp 140. The lamp voltage detector 120 also receives an input/feedback from the lamp 140. The lamp voltage detector 120 outputs the measured voltage of the lamp 140 to the additional cathode heating driver 130. The additional cathode current applied to the cathode (not shown here) may be, for example, more than double a test current of the cathode and sufficient to produce 10-15V across the cathode. This current is not applied to the lamp 140. The additional cathode heating driver 130 applies the additional cathode current to the cathode of the lamp 140 which reduces the damage occurring to the cathode during the glow phase of the lamp 140. The reduction of the glow phase peak current allows the lamp 140 to quickly ignite, e.g., in as little as less than 50 milliseconds (ms) after ignition while retaining a significant lifetime during rapid cycling testing and frequent switching use, without the need for pre-heating.

The lamp 140 is ignited by applying current to the lamp driver 110 using known methods, such as engaging a switch or similar apparatus. Following the transition of the lamp 140 from the glow phase to an arc phase, i.e., glow-to-arc transition (GAT), the voltage across the lamp 140 is reduced to the normal operating range, i.e., approximately 50-100V. During the arc phase, the additional heating current applied across the cathode is also significantly decreased to the normal operating range (i.e., approximately 3V) or is cutoff (i.e., reduced to 0V).

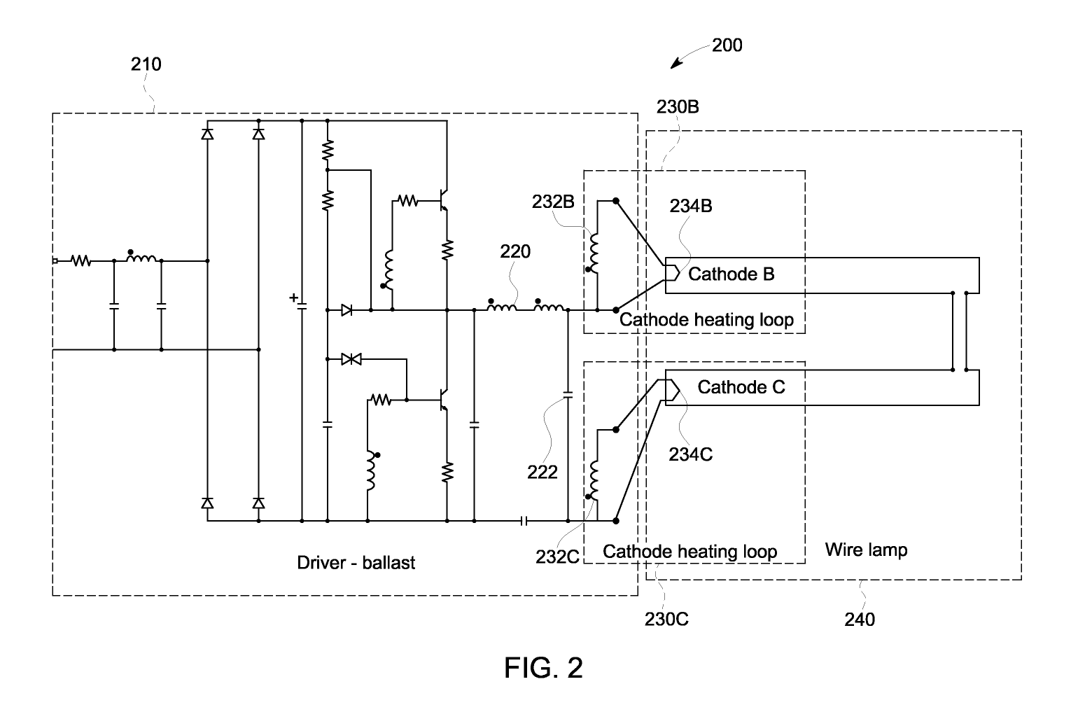

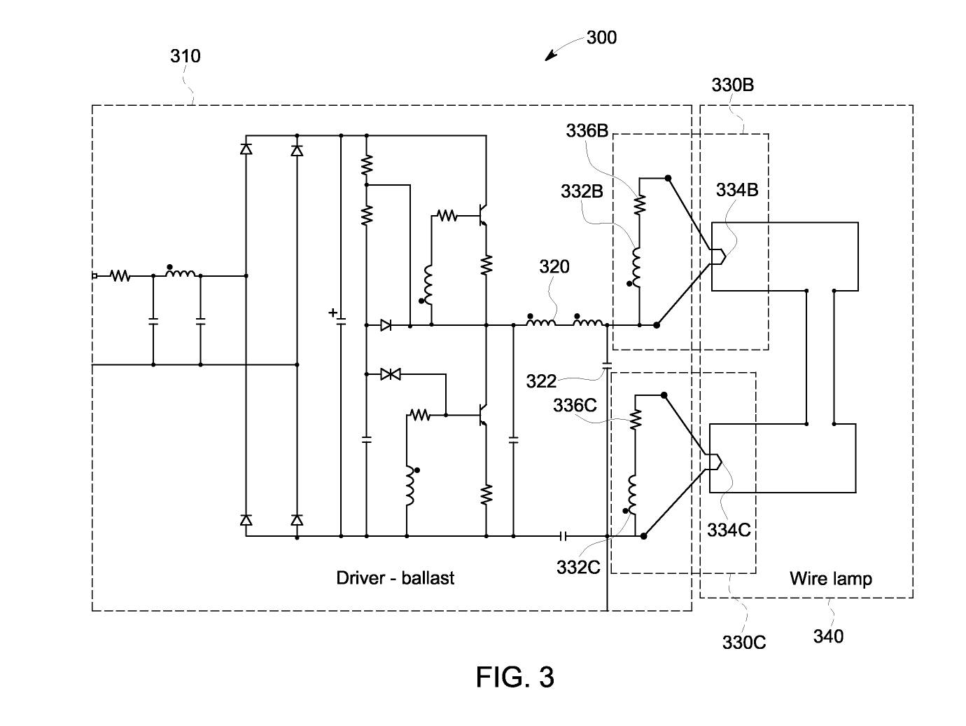

FIGS. 2 and 3, respectively, are more detailed illustrations of the self-ignited compact fluorescent lamp ballast 100 of FIG. 1. In FIG. 2, a self-ignited compact fluorescent lamp ballast circuit 200 includes a driver ballast circuit 210, a primary coil (inductor) 220, a first cathode heating loop 230B, a second cathode heating loop 230C, and a wire lamp 240. The driver ballast circuit 210 may be, for example, any suitable driver ballast for driving a general compact fluorescent lamp. The driver ballast circuit 210 also includes a parallel resonance capacitor 222. The first cathode heating loop 230B includes a secondary coil (inductor) 232B and a cathode 234B. The cathode 234B is connected to the legs of inductor 232B.

The second cathode heating loop 230C includes an inductor 232C and a cathode 234C. The cathode 234C is connected to legs of the inductor 232C. The driver ballast 210, unlike general lamp driver circuits, includes a transformer (or additional cathode heating driver) 220, 232B, 232C formed of the primary inductor 220 and secondary inductors 232B, 232C of the first cathode heating loop 230B and the second cathode heating loop 230C, respectively.

Cathodes 234B, 234C form wire lamp 240. The additional cathode heating driver 220, 232B, 232C causes a small amount of additional heat to be applied to the cathodes 234B, 234C during normal operation, i.e., steady state operation, of the lamp 240. A small amount of additional heat is applied to the cathodes 234B, 234C during the glow-to-arc phase, i.e., immediately following ignition of the lamp. The secondary inductors 232B, 232C cause the additional heat applied to the wire lamp 240, by the driver ballast circuit 210, to decrease following the glow-to-arc phase. The application of additional heat to the cathodes 232B, 232C immediately following ignition causes the glow current peaks of the lamp to be reduced and/or substantially eliminated. The additional cathode heating driver 220, 232B, 232C allows the glow current peaks of the lamp 240 to be reduced without increasing lamp current.

The additional cathode heating driver 220, 232B, 232C of the present embodiment is hardwired to the lamp 240 and replaces an inductor of a general lamp driver circuit. Hardwiring the additional cathode heating driver 220, 232B, 232C to the lamp 240 provides significantly high cathode heating immediately following ignition and causes the lamp to operate as an electronic circuit.

Ignition of the lamp 240 begins with a glow phase. During the glow phase, an increased high current is passed through the additional cathode heating driver 220, 232B, 232C which heats the cathodes 234B, 234C (and, in at least some embodiments, reduces the duration of the glow phase). The increased high current decreases the value of the arc current during the glow-to-arc phase following ignition of the lamp 240. No pre-heating or additional heating is applied to the cathodes 230B, 230C before ignition. The additional cathode heating is applied after the lamp 240 is ignited.

The additional cathode heating driver 220, 232B, 232C causes the lamp 240 to transition from the glow phase to the arc phase with reduced current peaks. By adding the extra heat at the cathodes 234B, 234C, the additional cathode heating driver 220, 232B, 232C reduces the peak current of the glow phase thereby limiting the damage to the lamp 240.

During operation, the driver circuit 210 applies a current to cathodes 234B, 234C via primary inductor 220. The current applied to cathodes 234B, 234C by the driver circuit 210 is increased during the glow-to-arc phase without increasing the current applied to the lamp 240. The lamp current passes from the first cathode 234B to the second cathode 234C. Limiting the current applied to the lamp 240 thereby improves efficiency and extends the life of the lamp 240.

FIG. 3 is an illustration of the self-ignited compact fluorescent lamp ballast circuit of the present invention according to an alternative embodiment. A lamp ballast circuit 300 is configured and performs similarly to the embodiment of the lamp ballast circuit 200, discussed above. The lamp ballast circuit 300 includes a driver ballast circuit 310, a primary coil (inductor) 320, a first cathode heating loop 330B, a second cathode heating loop 330C, and a wire lamp 340. The driver ballast circuit 310 also includes a parallel resonance capacitor 322. However, in addition to these elements, the lamp ballast 300 also includes resistors 336B, 336C, In this embodiment, resistors 336B, 336C are positive thermal coefficient, hereinafter PTCs, that act as switches. The resistance of PTCs 336B, 336C increases significantly due to the Joule heat generated by the current passing therethrough, i.e., the test current. The test current is defined, for example, in compact fluorescent lamp (CFL) technology as the current which heats up a cathode (in steady state) to a well-defined temperature (e.g., 4.75 times the resistance measured at 25 degrees C.). The PTCs thereby cut off the additional cathode heating current. While PTCs are shown in this embodiment, other types of switching devices, e.g., temperature controllers, timers, and the like may also be used to cut off the additional cathode heating current.

The first cathode heating loop 330B includes a secondary inductor 332B, a cathode 334B, and a PTC 336B. The secondary inductor 332B is connected in series with the PTC 336B. The secondary inductor 332B and PTC 336B are connected to legs of the cathode 334B.

Similarly, the second cathode heating loop 330C includes a secondary inductor 332C, a cathode 334C, and a PTC 336C. The secondary inductor 332C is connected in series with the PTC 336C. The secondary inductor of 332C and PTC 336C are connected to the legs of the cathode 334C. PTCs 336B, 336C, acting as switches, cause the additional cathode heating current, applied by the driver ballast circuit 310 to the wire lamp 340, to be cut off following the glow-to-arc phase.

The heating loops 230B, 230C, discussed above with respect to FIG. 2, cause the additional cathode heating current to decrease following the transition from glow-to-arc phase. The cathode heating loops 330B, 330C of ballast circuit 300, however, cause the additional cathode heating current to be cut off following the transition from glow-to-arc phase. The PTCs 336B, 336C, again acting as switches, prevent the additional cathode heating current from being applied to the legs of cathodes 334B, 334C, respectively.

Following the glow phase, the additional heating current applied to cathodes 334B, 334C by the driver ballast circuit 310 is cutoff and is not applied to the cathodes. The cathode heating loops 330B, 330C thereby prevent the additional heating current from being applied to the cathodes 334B, 334C during steady state operation of the lamp, i.e., after the transition from glow-to-arc. By preventing the additional heating from being applied to the lamp 340 during steady state operation, the cathode heating loops 330B, 330C reduce the losses on the cathodes.

Following ignition, during the glow phase of the lamp, the lamp voltage is significantly high, e.g., some hundreds of V. And at the same time the voltage on the primary inductor of the additional cathode heating driver is high, e.g., also some hundred volts, due to the resonant mode. Therefore, the voltage on the secondary inductors will also be high (e.g., 10-15V). The cathodes 334B, 334C receive the high voltage of the secondary inductors 332B, 332C which heat up the cathodes. For example, during steady state operation, the cathode voltage may be approximately 2-5 V. However, during the glow-to-arc phase, the cathode voltage will go high and may be in the range of approximately 10-15 V.

During ignition of the lamp 340, additional heat is applied to 334B, 334C to quickly heat the cathodes of wire lamp 340, thereby reducing the damage caused by the glow phase. During the first few hundred ms after ignition, the cathode heating loops 330B, 330C function substantially the same as the cathode heating loops 230B, 230C of FIG. 2. After the glow-to-arc transition, the PTCs 336B, 336C switch off the additional cathode heating.

Turning off the additional cathode heating during steady state operation removes the load applied by the additional cathode heating. During steady state operation, cathodes 234B, 234C are heated by the arc current. Because the additional heating is only needed during the glow phase and not during steady state operation, removing the load of the additional heating during steady state operation decreases the loss associated with the load, thereby increasing the efficacy of the circuit.

In the above mentioned embodiments, the voltage detection is solved indirectly on the circuits, e.g., lamp ballast circuits 200 and 300. Lamp current is closely related to the lamp voltage. In glow mode, i.e., when the lamp voltage is high, only a part of the current passes through the lamp, i.e., the wire lamp current. The larger portion of the current passes through the parallel resonance capacitors 222 and 322 in lamp ballast circuits 200 and 300, respectively. In FIG. 2, this parallel current, which is high in glow mode, passes through the primary inductor 220 of additional cathode heating driver 220, 232B, 232C. The parallel current induces the additional cathode heating current in both 232B, 232C. In this manner, the indirect voltage detector is the primary inductor 220 of the additional cathode heating driver 220, 232B, 232C, i.e., the voltage detector includes components of the driver ballast circuit 210. In an integrated circuit (IC) controlled ballast, the lamp voltage can be detected directly on the lamp. Similarly, the additional cathode heating driver 220, 232B, 232C also includes components of the driver ballast circuit 210.

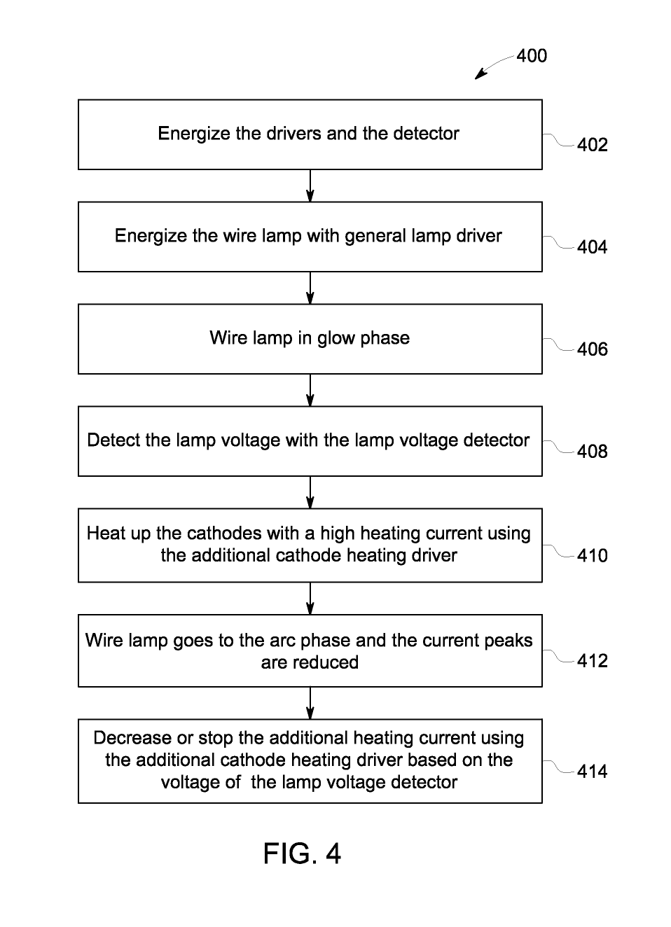

FIG. 4 is a flowchart of an exemplary method 400 of practicing an embodiment of the present invention. The method 400 provides the process for heating the cathode of a self-ignited compact fluorescent lamp (CFLi-s) in accordance with the embodiment. The method 400 begins at step 402 by energizing the lamp driver and the lamp voltage detector. At step 404, the wire lamp is energized (during ignition) by the lamp driver. At step 406, the wire lamp is in the glow phase.

At step 408, the lamp voltage detector detects the lamp voltage. The additional cathode heating will depend on the detected lamp voltage. At step 410, the additional cathode heating driver heats up the cathodes with a high heating current, e.g., about 0.5-1 ampere. During this phase, the cathode voltage is approximately 10-15V. At step 412, wire lamp goes to the arc phase (within as little as approximately 50 ms), the current peaks, i.e., the peak-to-peak current is reduced (from approximately 4.88 A-0.56 A. The cathode voltage drops from approximately 10-15 V to approximately 2-5 V. At step 414, the additional heating current applied by the additional cathode heating driver (based on the voltage measured by the lamp voltage detector) is decreased (to approximately 2-5V) or stopped.

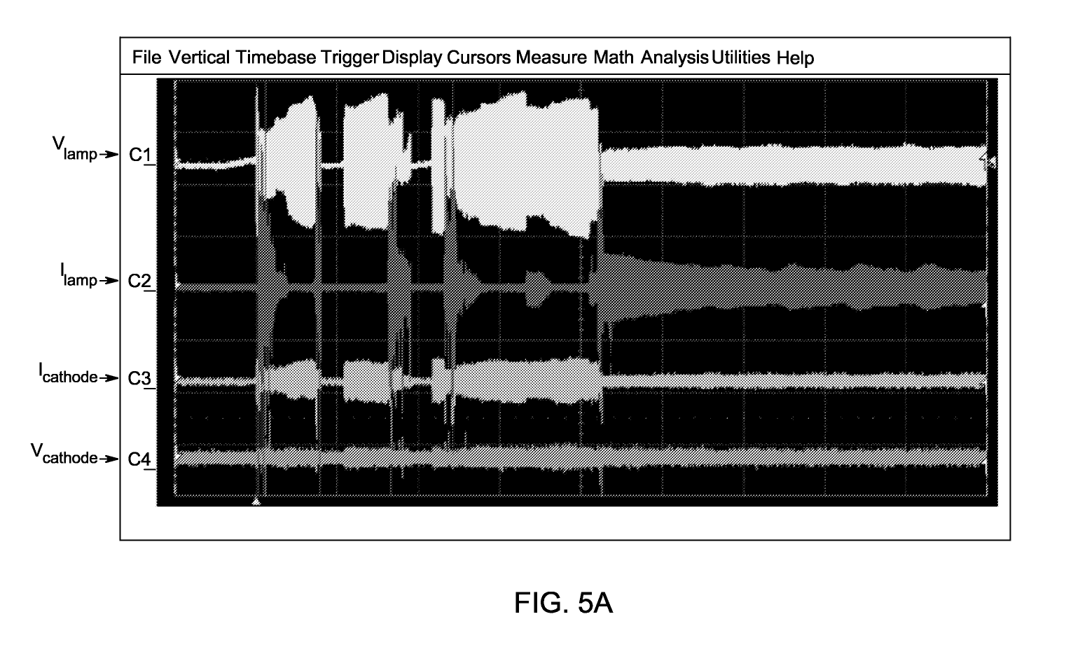

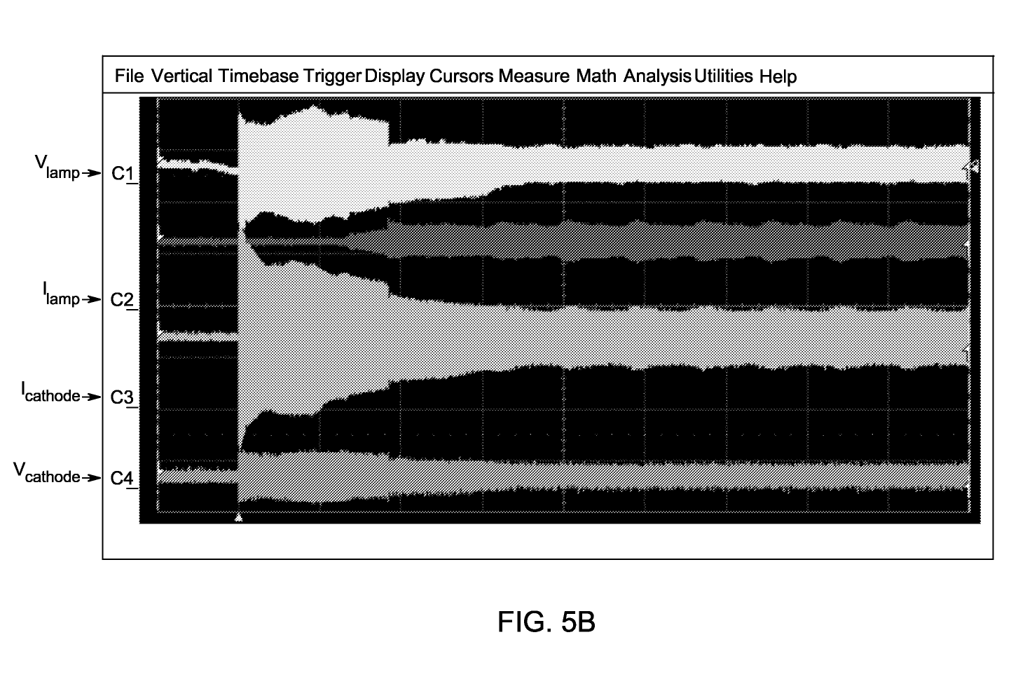

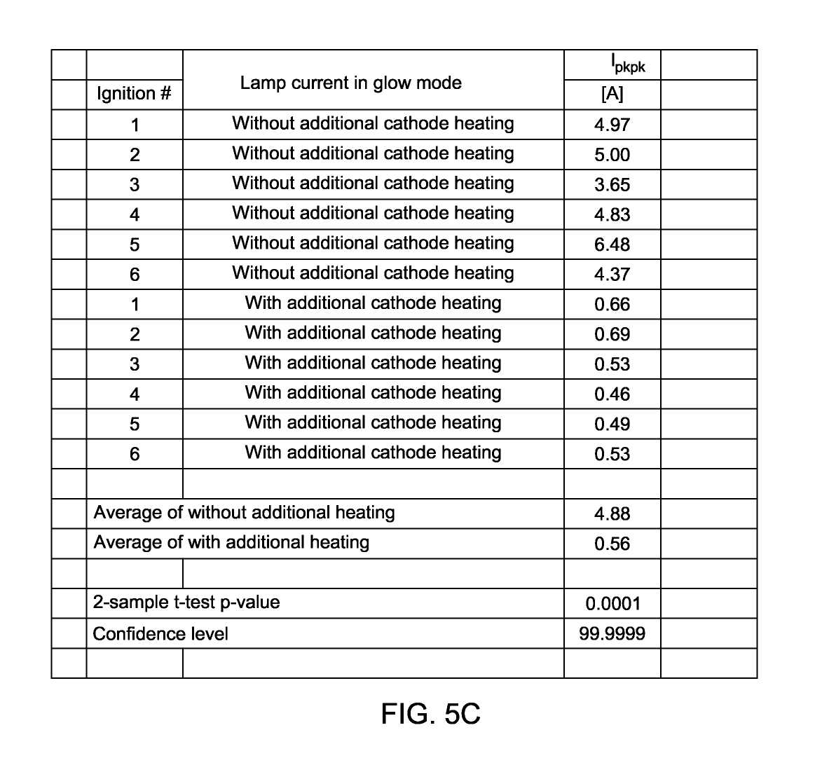

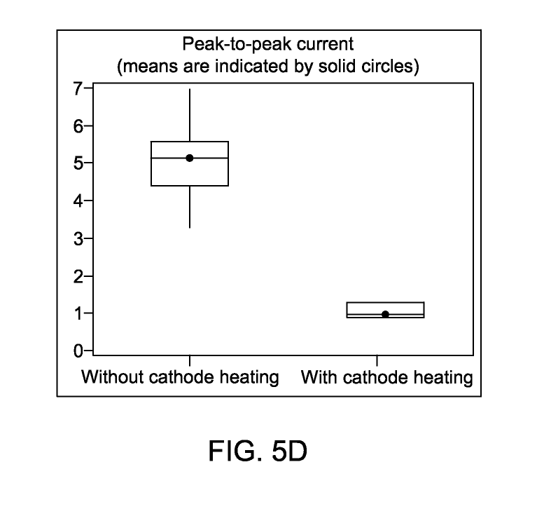

FIG. 5A is an exemplary screenshot of electrical measurements C1-C4 of a self-ignited compact fluorescent lamp without additional cathode heating. In FIG. 5A, Vₐₘₚ represents the lamp voltage. Iₐₘₚ represents the lamp current passing through the lamp. The ballast presents significantly high peaks in the lamp current (Iₐₘₚ) which cause damage to the cathode. I_{cathode} represents the additional cathode current passing through the cathode and secondary inductors but not the lamp. V_{cathode} represents the cathode voltage.

FIG. 5B is an exemplary screenshot of electrical measurements C1-C4 of a self-ignited compact fluorescent lamp with additional cathode heating. As shown in the screenshot, significantly higher additional current I_{cathode} is applied to the cathode. Applying significantly high additional current could present damage to the lamp. However, circuits in accordance with the embodiment allow additional cathode heating to be applied without presenting this hazard.

The circuits constructed in accordance with the embodiments, e.g., lamp ballast circuits 200, 300, normalize Iₗₐₘₚ by removing the unstable peaks of the lamp current as shown in FIG. 5A.

FIGS. 5C-5D provide details of exemplary lamp current measurements in accordance with FIGS. 5A and 5B. The peaks in current of the embodiments of the lighting ballast of FIG. 5A and FIG. 5B are compared over several ignition cycles, see FIG. 5C. As supported by the chart in FIG. 5C and the graph in FIG. 5D, the average of peak-to-peak current (Iₚₖₚₖ) is significantly reduced by applying additional heat to the cathode during the glow phase. For example, over six (6) ignition cycles, the average of Iₚₖₚₖ is reduced from 4.88 A to 0.56 A. By reducing the Iₚₖₚₖ the reliability of the lamp is improved.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

We claim:

1. A lighting system, comprising:
a wire lamp;
a lamp driver in communication with the wire lamp;
a lamp voltage detector in communication with the lamp driver and the wire lamp; and
a cathode heating driver in communication with the lamp voltage detector and the wire lamp, wherein the cathode heating driver applies heat to the wire lamp during glow phase.

2. The lighting system according to claim 1, wherein the added heat reduces the current peaks in glow phase of the wire lamp, and wherein the cathode heating driver is formed by a transformer.

3. The lighting system according the claim 1, wherein the lamp voltage detector is formed by one or more components of the lamp driver.

4. The lighting system according the claim 1, wherein the cathode heating driver is formed by one or more components of the lamp driver.

5. The lighting system according to claim 2, wherein the transformer comprises:
a primary inductor;
a first cathode heating loop in communication with the primary inductor, the first cathode heating loop including:
a first secondary inductor; and
a first cathode in communication with the first secondary inductor;
a second cathode heating loop in communication with the primary inductor, the second cathode heating loop including:
a second secondary inductor; and
a second cathode in communication with the second secondary inductor.

6. The lighting system according to claim 2, wherein the first cathode is connected to legs of the first secondary inductor, and the second cathode is connected to legs of the second secondary inductor.

7. The lighting system according to claim 2, wherein the transformer comprises:
a primary inductor;
a first cathode heating loop in communication with the primary inductor, the first cathode heating loop including:
a first secondary inductor;
a first switch in communication with the first secondary inductor; and
a first cathode in communication with the first secondary inductor and the firstswitch;
a second cathode heating loop in communication with the primary inductor, the second cathode heating loop including:
a second secondary inductor;
a second switch in communication with second secondary inductor; and
a second cathode in communication with the second secondary inductor and the second switch.

8. The lighting system according to claim 7, wherein the first switch and the second switch are positive thermal coefficient resistors.

9. The lighting system according to claim 7, wherein the first secondary inductor and the first switch are connected in series, and the second secondary inductor and the second switch are connected in series.

10. The lighting system according to claim 9, wherein the first cathode is connected to legs of the first secondary inductor and the firstswitch, and the second cathode is connected to legs of the second secondary inductor and secondswitch.

11. The lighting system according to claim 1, wherein the heat applied to the wire lamp is reduced following the glow phase.

12. The lighting system according to claim 1, wherein the heat applied to the wire lamp is cut off following the glow phase.

13. The lighting system according to claim 1, wherein the lamp driver is a general lamp driver.

14. The lighting system according to claim 1, wherein the voltage detector is formed by a primary inductor.

15. A lighting system, comprising:
a driver ballast in electrical communication with a lamp;
a cathode heating driver in communication with the driver ballast, wherein the cathode heating driver applies a heat to a lamp during glow phase and prior to arc phase of the lamp;
a first cathode heating loop in communication with the driver ballast, the first cathode heating loop including:
a first coil, and
a first cathode of the wire lamp in communication with the first coil;
a second cathode heating loop in communication with the driver ballast, the second cathode heating loop including:
a second coil; and
a second cathode of the wire lamp in communication with the second coil; and
a wire lamp having first and second cathodes, the wire lamp being in communication with the cathode heating driver, wherein the wire lamp receives heat from the cathode heating driver to reduce the peak current in glow phase of the wire lamp.

16. The lighting system according to claim 15, wherein the first cathode is connected to legs of the first secondary inductor, and the second cathode is connected to legs of the second secondary inductor.

17. The lighting system according to claim 15, wherein the cathode heating driver is formed by a transformer, the transformer includes:
a primary inductor;
a first secondary inductor of the first cathode heating loop; and
a second secondary inductor of the second cathode heating loop.

18. The lighting system according to claim 17, further comprising:
a first switching element in communication with the first coil and the first cathode of the wire lamp, wherein the first switching element is connected in series with the first coil, and the first cathode is connected to legs of the first switching element and the first coil; and
a second switching element in communication with the second coil and the second cathode of the wire lamp, wherein the second switching element is connected in series with the second coil, and the second cathode is connected to legs of the second switching element and the second coil.

19. A lighting method, comprising:
energizing a lighting driver and a lamp voltage detector;
energizing a wire lamp with the general lamp driver;
detecting lamp voltage via the lamp voltage detector; and
heating the cathodes of the wire lamp via a heating current applied by a cathode heating driver during glow phase.

20. The lighting method according to claim 19, further comprising:
decreasing the heating current following the wire lamp transitioning from glow to arc phase; or
stopping the heating current following the wire lamp transitioning from glow to arc phase.
